(19) United States
(12) Patent Application Publication
(10) Pub. No.: US 2026/0237989 A1
(43) Pub. Date: Aug. 13, 2026

(54) CLAMP ASSEMBLY FOR RELIEVING CABLE STRAIN

(71) Applicant: ADDÉNERGIE TECHNOLOGIES INC., Québec City (CA)

(72) Inventors: Luc TREMBLAY, Québec (CA); Dominic MARCEAU, Québec (CA)

(73) Assignee: ADDÉNERGIE TECHNOLOGIES INC., Québec City (CA)

(21) Appl. No.: 19/050,793

(22) Filed: Feb. 11, 2025

(51) Int. Cl. H02G 3/32

(52) U.S. Cl. CPC H02G 3/32

(57) ABSTRACT

A clamp assembly for securing an electric cable to a device is described. The clamp assembly comprises a first piece and a second piece. The first piece includes: a first concave portion on one side of the first piece and a second concave portion on an opposite side. The second piece is similarly structured and includes a third concave portion and a fourth large concave portion. The second concave portion has a greater depth than the first concave portion and the fourth concave portion has a greater depth than the third concave portion. The first piece and second piece are coupled such that the first piece and the second piece define an opening with a perimeter such that one of the concave portions of the first piece and one of the concave portions of the second piece are part of the perimeter.

### FIELD

The present application relates to a clamp assembly for securing a cable or electric cable to a charging station or electric charging station.

### BACKGROUND

Electric vehicles (EVs) have increased in popularity in recent years. Conventional EVs require charging at a charging station or electric charging station in order to run. At these charging stations, a cable, charging cable, or electric cable connects an EV to a charging station. In a conventional setup, connecting the cable to the charging station puts the cable under strain. More particularly, applying force to the cable can detach the cable from its point of connection with the charging station.

In some instances, a cable connecting a charging source to electrical power may also be put under strain. For example, it some instances, the cable may be pulled during installation or may be caught on something after installation, putting strain on the charging station.

There is need for an apparatus, such as the clamp assembly disclosed herein, that can relieve the strain on the cable. Specifically, there is need for an apparatus that decreases the likelihood of the cable detaching from the charging station upon application of force. Moreover, it is desirable for such an apparatus to be able to relieve strain on cables connected to different types of charging stations. Hence, it is desirable for such an apparatus to be installable onsite.

### BRIEF DESCRIPTION OF THE DRAWINGS

Reference will now be made, by way of example, to the accompanying drawings which show example embodiments of the present application, and in which:

FIG. 1 shows a perspective view of a clamp assembly installed inside a charging station;

FIG. 2 shows a transparent perspective view of the clamp assembly in FIG. 1 to show the internal structure;

FIG. 3 shows a bottom-side-back perspective view of a first piece of the clamp assembly;

FIG. 4 shows a top-side-front perspective view of the first piece shown in FIG. 3;

FIG. 5 shows a front view of the clamp assembly in an arrangement for securing a cable of a first range of thickness;

FIG. 6 shows a front view of the clamp assembly in an arrangement for securing a cable of a second range of thickness;

FIG. 7 shows a front view of the clamp assembly in an arrangement for securing a cable of a third range of thickness.

Similar reference numerals may have been used in different figures to denote similar components.

### DETAILED DESCRIPTION

In an aspect, the present application discloses a clamp assembly for securing an electric cable to a device and accommodating multiple cable thicknesses. The clamp assembly includes a first piece. The first piece includes a first side, the first side having a first concave portion with a first depth; and a second side on a side of the first piece opposite the first side, the second side having a second concave portion with a second depth, the second depth being greater than the first depth. The clamp assembly further includes a second piece selectively coupled to the first piece, the second piece including a third side configured to be selectively couplable to the first side and the second side, the third side having a third concave portion with a third depth. The third concave portion is configured to align with the first concave portion when the third side is selectively coupled to the first side; and align with the second concave portion when the third side is selectively coupled to the second side. Selectively coupling the third side to one of the first side and the second side causes the third side and the one of the first side and the second side to define a first opening with a first perimeter, one of the first concave portion and the second concave portion being part of a first section of the first perimeter and the third concave portion being part of a second section of the first perimeter.

In some implementations, the second piece further includes a fourth side configured to be selectively couplable to the first side and the second side. The fourth side has a fourth concave portion with a fourth depth, the fourth depth being greater than the third depth. The fourth concave portion is configured to align with the first concave portion when the third side is selectively coupled to the first side; and align with the second concave portion when the third side is selectively coupled to the second side. Selectively coupling the fourth side to one of the first side and the second side causes the fourth side and the one of the first side and the second side to define a second opening with a second perimeter, one of the first concave portion and the second concave portion being part of a first section of the second perimeter and the third concave portion being part of a second section of the second perimeter.

In some implementations, selectively coupling the first side to the third side allows the clamp assembly to accommodate a cable having a thickness between 14mm and 17mm.

In some implementations, selectively coupling the second side to the third side allows the clamp assembly to accommodate a cable having a thickness between 18mm and 21mm.

In some implementations, selectively coupling the third side to the fourth side allows the clamp assembly to accommodate a cable having a thickness between 22mm and 25mm.

In some implementations, the first piece defines a first hole extending therethrough. The second piece defines a second hole extending therethrough, the second hole being configured to align with the first hole when the first concave portion aligns with the third concave portion. Selectively coupling the first piece to the second piece further includes inserting a fastener through the first hole and the second hole.

In some implementations, the first hole has a receiving area at an end of the first hole. The receiving area has a greater radius than another area of the first hole. The clamp assembly attaches to a housing by receiving, via the receiving area, a protruding part of the housing.

In some implementations, the protruding part includes a fastening area configured to receive the fastener. Attaching the clamp assembly to the housing further includes aligning the first hole, the second hole, and the fastening area; and inserting the fastener through the first hole, the second hole, and the fastening area.

In some implementations, the first piece and the second piece have a common shape.

In some implementations, securing the electric cable to the device includes passing the electric cable through the first opening.

In another aspect, the present application discloses a housing of a device designed to secure an electric cable to the device and accommodate multiple cable thicknesses. The housing is coupled to a clamp assembly. The clamp assembly includes a first piece. The first piece includes a first side, the first side having a first concave portion with a first depth; and a second side on a side of the first piece opposite the first side, the second side having a second concave portion with a second depth, the second depth being greater than the first depth. The clamp assembly further includes a second piece selectively coupled to the first piece, the second piece including a third side configured to be selectively couplable to the first side and the second side, the third side having a third concave portion with a third depth. The third concave portion is configured to align with the first concave portion when the third side is selectively coupled to the first side; and align with the second concave portion when the third side is selectively coupled to the second side. Selectively coupling the third side to one of the first side and the second side causes the third side and the one of the first side and the second side to define a first opening with a first perimeter, one of the first concave portion and the second concave portion being part of a first section of the first perimeter and the third concave portion being part of a second section of the first perimeter.

In some implementations, the second piece further includes a fourth side configured to be selectively couplable to the first side and the second side. The fourth side has a fourth concave portion with a fourth depth, the fourth depth being greater than the third depth. The fourth concave portion is configured to align with the first concave portion when the third side is selectively coupled to the first side; and align with the second concave portion when the third side is selectively coupled to the second side. Selectively coupling the fourth side to one of the first side and the second side causes the fourth side and the one of the first side and the second side to define a second opening with a second perimeter, one of the first concave portion and the second concave portion being part of a first section of the second perimeter and the third concave portion being part of a second section of the second perimeter.

In some implementations, selectively coupling the first side to the third side allows the housing to accommodate a cable having a thickness between 14mm and 17mm.

In some implementations, selectively coupling the second side to the third side allows the housing to accommodate a cable having a thickness between 18mm and 21mm.

In some implementations, selectively coupling the third side to the fourth side allows the clamp assembly to accommodate a cable having a thickness between 22mm and 25mm.

In some implementations, the first piece defines a first hole extending therethrough. The second piece defines a second hole extending therethrough, the second hole being configured to align with the first hole when the first concave portion aligns with the third concave portion. Selectively coupling the first piece to the second piece further includes inserting a fastener through the first hole and the second hole.

In some implementations, the housing further includes a protruding part. The first hole has a receiving area at an end of the first hole. The receiving area has a greater radius than another area of the first hole. The clamp assembly attaches to the housing by receiving, via the receiving area, the protruding part.

In some implementations, the protruding part includes a fastening area configured to receive the fastener. Attaching the clamp assembly to the housing further includes aligning the first hole, the second hole, and the fastening area; and inserting the fastener through the first hole, the second hole, and the fastening area.

In some implementations, the first piece and the second piece have a common shape.

In some implementations, securing the electric cable to the device comprises passing the electric cable through the first opening.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrases “at least one of …and…” is intended to cover any one or more of the listed elements, including any one of the listed elements alone, any sub-combination, or all of the elements, without necessarily excluding any additional elements, and without necessarily requiring all of the elements. Similarly, the phrase “at least one of …or…” is also intended to cover any one or more of the listed elements, including any one of the listed elements alone, any sub-combination, or all of the elements, without necessarily excluding any additional elements, and without necessarily requiring all of the elements.

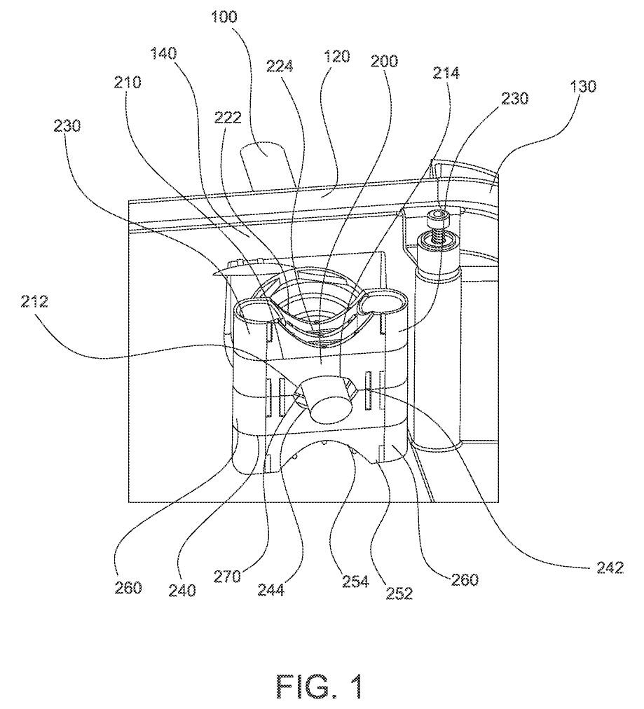

Reference is made to FIG. 1 which shows a perspective view of a clamp assembly 200 for securing an electric cable 100 to a device or electric charging station 120. FIG. 1 shows the clamp assembly 200 being installed or placed on an inner side of an exterior wall 140 of the electric charging station 120. Additionally or alternatively, the clamp assembly 200 is installed or placed inside a housing 130. Further, the cable 100 passes through, from an area external to the electric charging station 120 or the housing 130, the exterior wall 140 or the housing 130. After passing through the exterior wall 140 or the housing 130, the cable 100 continues to pass through and is secured by the clamp assembly 200. In particular, FIG. 1 shows the cable 100 passing through an opening or first opening 270 defined by the clamp assembly 200. By securing the cable 100, the clamp assembly 200 relieves strain on the cable 100. In particular, the clamp assembly 200 may prevent excessive bending of the cable 100 at its point of contact with the electric charging station 120. Additionally or alternatively, the clamp assembly 200 may prevent the cable 100 from detaching from the electric charging station 120 upon an exertion or application of force on the cable 100.

The clamp assembly 200 includes a first piece 210 and a second piece 240 selectively coupled to the first piece 210. Further, the first piece 210 includes a first side 212 having a first concave portion 214. The first piece 210 also includes a second side 222 having a second concave portion 224. The first side 212 is on one side of the first piece 210 and the second side 222 is on a side opposite the first side 212. Likewise, the second piece 240 includes a third side 242 having a third concave portion 244 and a fourth side 252 having a fourth concave portion 254. The third side 242 is on one side of the second piece 240 and the fourth side 252 is on a side opposite the third side 242. The third side 242 may be configured to be selectively couplable to the first side 212 and the second side 222. Likewise, the fourth side 252 may be configured to be selectively couplable to the first side 212 and the second side 222. Further, the third concave portion 244 may be configured to align with the first concave portion 214 when the third side 242 is selectively coupled to the first side 212. Likewise, the third concave portion 244 may be configured to align with the second concave portion 224 when the third side 242 is selectively coupled to the second side 222. Further, the fourth concave portion 254 may be configured to align with the first concave portion 214 when the fourth side 252 is selectively coupled to the first side 212. Likewise, the fourth concave portion 254 may be configured to align with the second concave portion 224 when the fourth side 252 is selectively coupled to the second side 222. The first piece 210 also includes a first pair of lateral sides 230 extending between the first side 212 and the second side 222. Likewise, the second piece 240 includes a second pair of lateral sides 260 extending between the third side 242 and the fourth side 252. While FIG. 1 illustrates the first pair of lateral sides 230 and the second pair of lateral sides 260 as cylindrical, in other embodiments, such lateral sides may have other shapes including prismatic shapes.

In some embodiments, the first concave portion 214 may be smaller than the second concave portion 224. For example, the second concave portion 224 may have a second depth that is greater than a first depth of the first concave portion 214. Additionally or alternatively, the second concave portion 224 may have a second radius that is greater than a first radius of the first concave portion 214. Additionally or alternatively, when respectively measured in a direction along the first side 212 or the second side 222, the second concave portion 224 may be longer than the first concave portion 214. The same applies to the third concave portion 244 and the fourth concave portion 254. That is, in some embodiments, the third concave portion may have a third depth and the fourth concave portion may have a fourth depth wherein the fourth depth is deeper or greater than the third depth.

FIG. 1 shows the first piece 210 and the second piece 240 being selectively coupled such that the first side 212 makes physical contact with, at least in part, the third side 242. In particular, the first piece 210 and the second piece 240 are coupled such that the clamp assembly 200 defines the opening or first opening 270. In particular, the first concave portion 214 is part of a first section of a perimeter or first perimeter of the opening 270 and the third concave portion 244 is a part of a second section of the perimeter of the opening 270.

While FIG. 1 shows the first piece 210 and the second piece 240 coupled in a configuration wherein the first side 212 faces the third side 242, the first piece 210 and the second piece 240 may be selectively coupled in an alternative configuration. For example, the first piece and the second piece 240 may be selectively coupled such that 1) one of the first side 212 and the second side 222 and 2) one of the third side 242 and the fourth side 252 makes, at least in part, physical contact with each other. That is, 1) one of the first side 212 and the second side 222, and 2) one of the third side 242 and the fourth side 252 may face each other. Likewise, while FIG. 1 shows the opening 270 to be defined, at least in part, by the first concave portion 214 and the third concave portion 244, the first piece 210 and the second piece 240 may be selectively coupled to define an opening of a different size, shape, or both. For example, the first piece 210 and the second piece 240 may be coupled to define an opening defined, at least in part, by 1) one of the first concave portion 214 and the second concave portion 224 and 2) one of the third concave portion 244 and the fourth concave portion 254. In this example, 1) one of the first concave portion 214 and the second concave portion 224 may be part of a first section of the perimeter and 2) one of the third concave portion 244 and the fourth concave portion 254 may be part of a second section of the perimeter.

The various sizes and shapes of openings that can be accommodated by the clamp assembly 200 may allow the clamp assembly 200 to secure and relieve the strain of cables of various sizes and shapes. For example, the opening 270 may accommodate a cable with a diameter between 14mm and 17mm. In another example, an opening or second or third opening defined by the first concave portion 214 and the fourth concave portion 254 may accommodate a cable with a diameter between 18mm and 21mm. In another example, an opening or second or third opening defined by the second concave portion 224 and the fourth concave portion 254 may accommodate a cable with a diameter between 22mm and 25mm.

FIG. 1 shows the first concave portion 214, the second concave portion 224, the third concave portion 244, and the fourth concave portion 254 to be curved or elliptic. In other embodiments, any such concave portions of the first piece and the second piece may have a different shape or curvature. Possible shapes or curvatures for such concave portions include without limitation linear, angular, polygonal, circular, curved, elliptic, or a combination thereof.

FIG. 1 shows the first piece 210 and the second piece 240 to be identical, be identical pieces, or have common shapes. In other embodiments, the first piece and the second piece may not be identical. For example, the clamp assembly may define an opening wherein a section of a perimeter of the opening defined by the first piece is curved and a section of the perimeter defined by the second piece is angular.

In some embodiments, the clamp assembly may have more than two pieces. For example, the clamp assembly may include a first, second, and third piece coupled in series wherein the first and second pieces define a first opening and the second and third pieces define a second opening. These two openings may be used to secure different cables. That is, a series of clamp assembly pieces may be used to secure multiple cables to an electric charging station. In this example, one of the pieces, such as the second piece, may have an adjustable length, thereby allowing the first opening and the second opening to be spaced at different distances relative to each other. The different possible distances between the first opening and the second opening may accommodate different or varying distances between points of connection for multiple cables to a single electric charging station.

In some embodiments, heat-resistant material may be used to construct part of the clamp assembly 200 such as the first piece 210 and the second piece 240. In some embodiments, insulating material may be used to construct part of the clamp assembly 200 such as the first piece 210 and the second piece 240. Examples of heat-resistant and insulating materials include without limitation polycarbonate materials or polycarbonates.

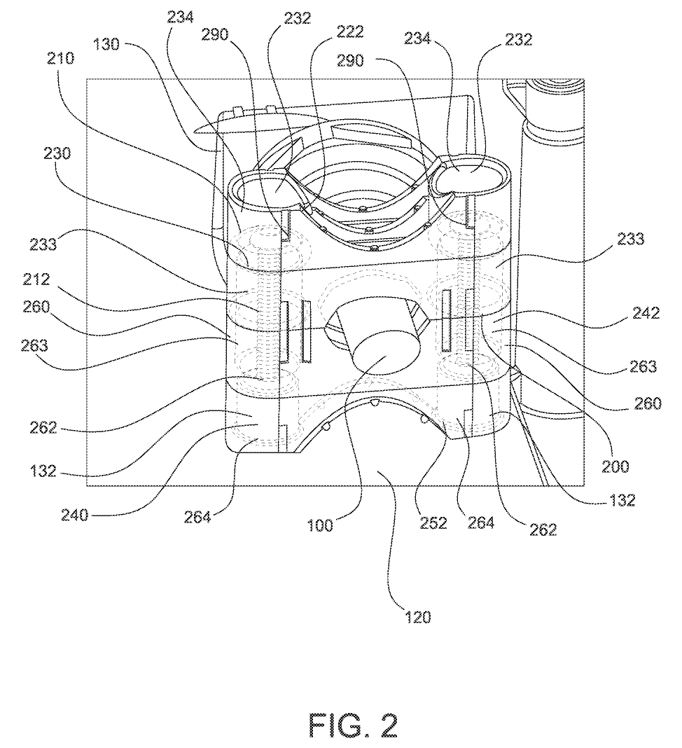

Reference is now made to FIG. 2 which shows a transparent perspective view of the clamp assembly 200 in FIG. 1. The clamp assembly 200 secures the cable 100 and includes the first piece 210, the second piece 240, the first pair of lateral sides 230, and the second pair of lateral sides 260 (as also shown in FIG. 1).

FIG. 2 shows the first piece 210 having a pair of first holes 232. In particular, each of the first pair of lateral sides 230 defines its own respective one of the pair of first holes 232. Further, each of the pair of first holes 232 extends along and through its respective one of the first pair of lateral sides 230. That is, the first piece 210 defines a first hole 232 extending therethrough. In alternative wording, at least one of the first pair of lateral sides 230 defines a first hole 232 extending along and through the one of the first pair of lateral sides 230.

FIG. 2 shows the second piece 240 having a similar structure to the first piece 210. That is, the second piece 240 has a pair of second holes 262. Each of the second pair of lateral sides 260 defines its own respective one of the pair of second holes 262. Each of the pair of second holes 262 extends along and through its respective one of the second pair of lateral sides 260. That is, the second piece 240 defines a second hole or second hole 262 extending therethrough. In alternative wording, at least one of the second pair of lateral sides 260 defines a second hole 262 extending along and through the one of the second pair of lateral sides 260.

When selectively coupling the first piece 210 and the second piece 240, the pair of first holes 232 and the pair of second holes 262 may align. In particular, the second hole 262 may be configured to align with the first hole 232 when one of the first concave portion 214 and the second concave portion 224 aligns with one of the third concave portion 244 and the fourth concave portion 254.

In some embodiments, at least one of the pair of first holes 232 or at least one of the pair of second holes 262 may be a threaded hole. For example, the pair of first holes 232 may each have a threaded portion. Likewise, the pair of second holes 262 may each have a threaded portion.

In some embodiments, the clamp assembly 200 may include one or more caps to cover one or more of the pair of first holes 232 or one or more of the pair of second holes 262.

FIG. 2 further shows a pair of fasteners 290. In FIG. 2, the fasteners 290 are screws. Each of the pair of fasteners 290 may be inserted into a pair of bores formed by aligning the pair of first holes 232 with the pair of second holes 262. That is, one of the pair of fasteners 290 may be inserted through one of the first holes 232 and one of the second holes 262. In particular, selectively coupling the first piece 210 and the second piece 240 may include inserting the pair of fasteners 290 through the pair of first holes 232 and the pair of second holes 262.

FIG. 2 shows that the pair of first holes 232 are configured such that each of the pair of fasteners 290 are screwed toward the first side 212 from the second side 222, or in a downward direction (the downward direction shall refer to a direction corresponding to traversing from a side with a “lesser” or “shallower” concave portion to a side with a “greater” or “deeper” concave portion throughout the present application). FIG. 2 further shows that the pair of second holes 262 are configured such that each of the pair of fasteners 290 are screwed toward the fourth side 252 from the third side 242, or in an upward direction (the upward direction shall refer to a direction corresponding to traversing from side with a “greater” or “deeper” concave portion to a side with a “lesser” or “shallower” concave portion throughout the present application). In some embodiments, the pairs of first and second holes 232 and 262 may configure different screwing directions for the pair of fasteners 290. For example, one of the pair of first holes 232 may facilitate a downward screwing direction while the other facilitates an upward screwing direction. Likewise, one of the pair of second holes 262 may facilitate a downward screwing direction while the other facilitates an upward screwing direction. In another embodiment, at least one of the pair of first holes 232 and at least one of the pair of second holes 262 may facilitate screwing in both the downward and upward directions.

While FIG. 2 shows a pair of fasteners 290 and that the first piece 210 and the second piece 240 each have a pair of holes 232 and 262, other embodiments may have different configurations. For example, the first piece 210 and the second piece 240 may each have a single hole wherein a single fastener is used to couple the first piece 210 and the second piece 240. Additionally or alternatively, one of the first pair of laterals sides 230 and one of the second pair of lateral sides 260 may facilitate or define multiple fastening holes. For example, one of the first pair of lateral sides 230 may have a fastening hole facilitating a downward screwing direction and another fastening hole facilitating an upward screwing direction. In this example, two screws may thread a respective fastening hole in the one of the first pair of lateral sides 230 when selectively coupling the first piece 210 to the second piece 240.

FIG. 2 further shows that the housing 130 has a pair of protruding parts 132. The pair of protruding parts 132 are configured to align with the pair of first holes 232 and the pair of second holes 262. Further, each of the pair of protruding parts may have a fastening area configured to receive a fastener such as one of the fasteners 290. In some embodiments, the fastening area may be a threaded hole for receiving a screw. Further, FIG. 2 shows that each of the pair of first holes 232 and each of the pair of second holes 262 has at least one receiving area for receiving one of the protruding parts 132. For example, each of the pair of first holes 232 has a first receiving area 233 at an end of first hole 232 ending at the first side 212. Each of the pair of first holes 232 also has a second receiving area 234 at an end of the first hole 232 ending at the second side 222. Likewise, each of the pair of second holes 262 has a third receiving area 263 at an end of the second hole 262 ending at the third side 242. Likewise, each of the pair of second holes 262 has a fourth receiving area 264 at an end of the second hole 262 ending at the fourth side 252. In some embodiments, the radius of the receiving areas may be greater than the radius of another part of the same hole (the first hole 232 or second hole 262). Additionally or alternatively, the part of first hole 232 or the second hole 262 corresponding to the receiving areas may be wider or larger than other parts of the same hole. Forming the clamp assembly 200 and securing, attaching, or coupling the clamp assembly 200 to the housing 130 may be done by 1) having one of the pair of first receiving areas 233, the pair of second receiving areas 234, the pair of third receiving areas 263, and the pair of fourth receiving areas 264 receive the pair of protruding parts 132, 2) aligning the pair of protruding parts 132 with the pair of first holes 232 and the pair of second holes 262 (one of the pairs of holes may automatically be aligned with the pair of protruding parts 132 via the receiving step, i.e. step 1)), 3) passing the pair of fasteners 290 through the pair of first holes 232 and the pair of second holes 262, 4) and securing or fastening the pair of fasteners 290 to the pair of protruding parts 132. FIG. 2 shows the pair of fourth receiving areas 264 receiving the pair of protruding parts 132.

While FIG. 2 illustrates screwing as the mechanism used to attach the first piece 210 to the second piece 240, other embodiments may use different attaching or coupling mechanisms. In some embodiments, rotating hooks may be used to attach the first piece 210 to the second piece 240. For example, a first rotating hook that can rotate to a position such that the first rotating hook protrudes out relative to the first side 212 may be coupled to one of the first pair of lateral sides 230. Likewise, a second rotating hook that can rotate to a position such that the second rotating hook protrudes out relative to the third side 242 may be coupled to one of the second pair of lateral sides 260. In this example, attaching the first piece 210 to the second piece 240 may including hooking the first rotating hook to the second rotating hook. In this example, the first piece 210 and second piece 240 may have other rotating hooks for the purpose of attaching the first piece 210 to the second piece 240.

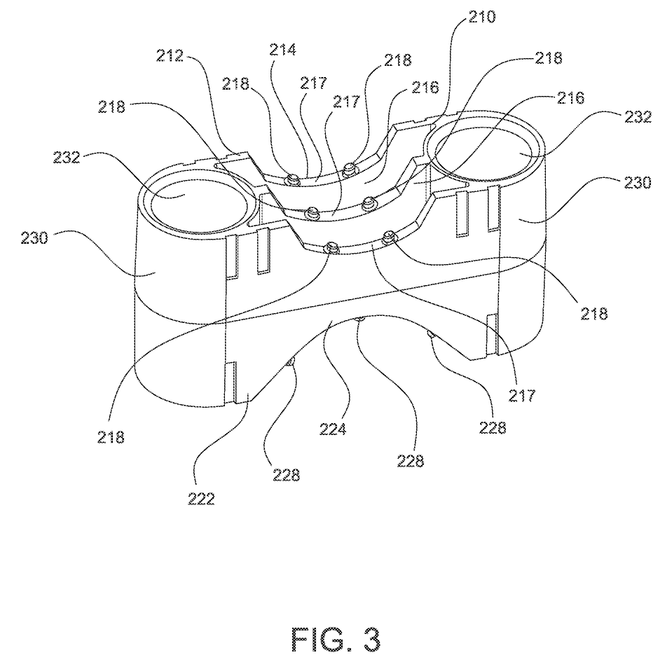

Reference is now made to FIG. 3 which shows a bottom-side-back perspective view of the first piece 210 of the clamp assembly 200 in FIG. 1. The second piece 240 (see FIG. 1 or FIG. 2) may have similar features to or be identical to the first piece 210. Thus, the description of the first piece 210 with reference to FIG. 3 may also be applicable to the second piece 240.

FIG. 3 shows the first piece 210 having the first side 212, the first concave portion 214, the second side 222, the second concave portion 224, the first pair of lateral sides 230, and the pair of first holes 232. FIG. 3 further shows the first side 212 defining one or more first grooves 216 extending along the first concave portion 214. The one or more first grooves 216 separate a plurality of first ridges 217. When securing a cable with the clamp assembly 200, part of the cable may sink or fill in parts of the first grooves 216. Such sinking or filling in may allow for a tighter securement of the cable.

FIG. 3 further shows a plurality of first teeth 218 protruding along the first concave portion 214. In particular, the first teeth 218 are protruding along each, or at least one of, the first ridges 217. The first teeth 218 may help secure a cable when the clamp assembly 200 is assembled and the first concave portion 214 is part of the surface clamping the cable.

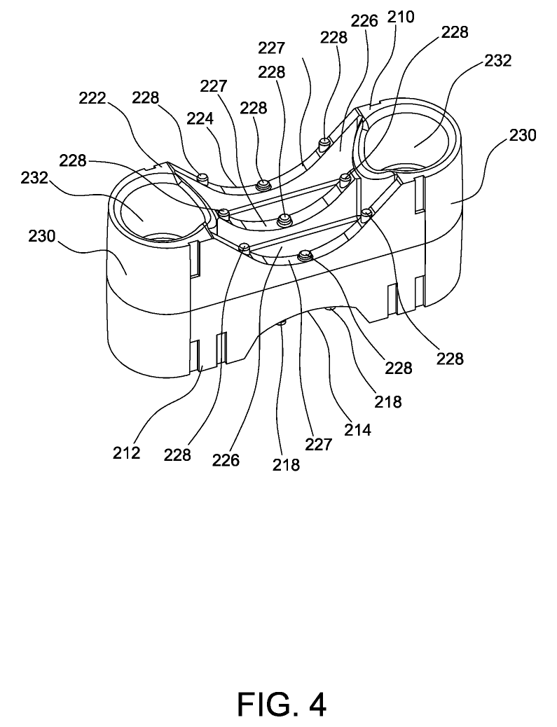

Reference is now made to FIG. 4 which shows a top-side-front perspective view of the first piece 210 shown in FIG. 3. The second piece 240 (see FIG. 1 or FIG. 2) may have similar features to or be identical to the first piece 210. Thus, the description of the first piece 210 with reference to FIG. 4 may also be applicable to the second piece 240.

FIG. 4 shows the first piece 210 having the first side 212, the first concave portion 214, the plurality of first teeth 218, the second side 222, the second concave portion 224, the first pair of lateral sides 230, and the pair of first holes 232. FIG. 4 further shows the second side 222 defining one or more second grooves 226 extending along the second concave portion 224. The one or more second grooves 226 separate a plurality of second ridges 227. When securing a cable with the clamp assembly 200, part of the cable may sink or fill in parts of the second grooves 226. Such sinking or filling in may allow for a tighter securement of the cable.

FIG. 4 further shows a plurality of third teeth 228 protruding along the second concave portion 224. In particular, the third teeth 228 are protruding along each, or at least one of, the second ridges 227. The third teeth 228 may help secure a cable when the clamp assembly 200 is assembled and the second concave portion 224 is part of the surface clamping the cable.

In some embodiments, the one or more first grooves 216 (see FIG. 3) may be the same as the one or more second grooves 226. That is, the one or more second grooves 226 (or first grooves 216) may extend downward (or upward) through the first piece 210.

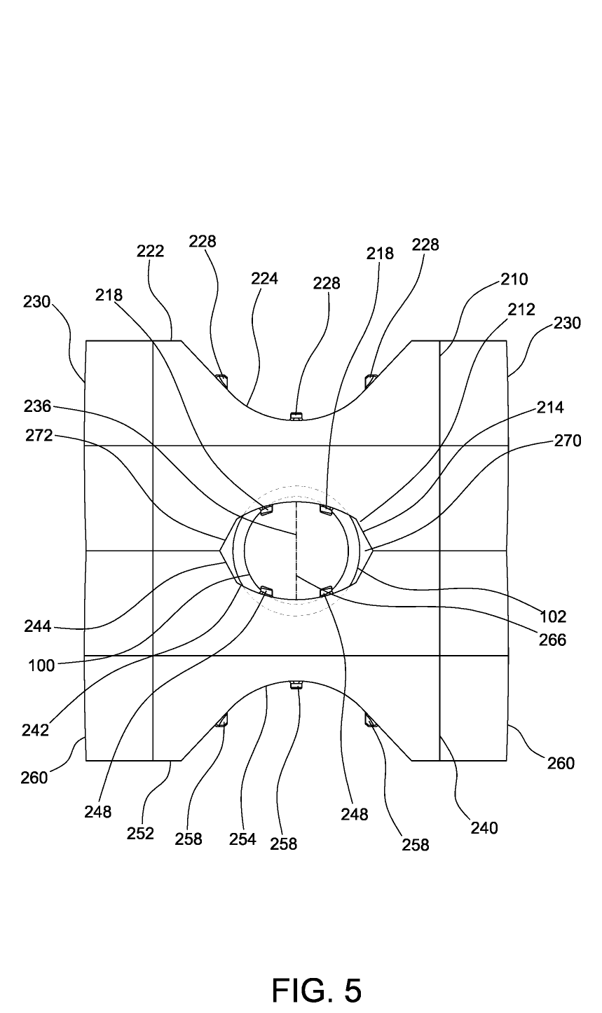

Reference is now made to FIG. 5 which shows a front view of the clamp assembly 200 (see FIG. 1) in a first arrangement for securing a cable of a first range of thickness. FIG. 5 shows, as seen in FIGS. 1-4, the clamp assembly 200 includes the first piece 210 and the second piece 240. The first piece 210 includes the first side 212, the first concave portion 214, the plurality of first teeth 218, the second side 222, the second concave portion 224, the plurality of third teeth 228, and the first pair of lateral sides 230. The second piece 240 includes the third side 242, the third concave portion 244, a plurality of second small concave portion teeth 248, the fourth side 252, the fourth concave portion 254, a plurality of second large concave portion teeth 258, and the second pair of lateral sides 260. FIG. 5 further shows the first concave portion 214 having a first depth 236 and the third concave portion 244 having a third depth 266.

In the first arrangement, the first piece 210 is coupled to the second piece 240 such that the first side 212 makes physical contact with or faces the third side 242. Further, the clamp assembly 200 defines a first opening 270 with a first perimeter 272. In particular, the first concave portion 214 is part of a first section of the first perimeter 272 and the third concave portion 244 is part of a second section of the first perimeter 272.

In an overlayed format, FIG. 5 also illustrates the clamp assembly 200 securing cables of different thickness by having the cables pass through the first opening 270. In particular, the clamp assembly 200 is shown securing a cable 100 having a 14mm diameter or a cable 102 having a 17mm diameter. It may be appreciated that in this first arrangement, the clamp assembly 200 may secure cables having a diameter within a first range wherein the first range includes 14mm and 17mm.

FIG. 5 shows the clamp assembly 200 securing the cables 100 and 102 by having the cables 100 and 102 pass through the first opening 270. In particular, the first concave portion 214 and the third concave portion 244 clamp down or apply pressure on the cables 100 and 102. The plurality of first teeth 218 and the plurality of second small concave portion teeth 248 provide additional securing force or pressure.

FIG. 5 shows both the cables 100 and 102 sinking into the first concave portion 214 and the third concave portion 244. It may be appreciated that the cables 100 and 102 are sinking into grooves such as the one or more first grooves 216 (see FIG. 3).

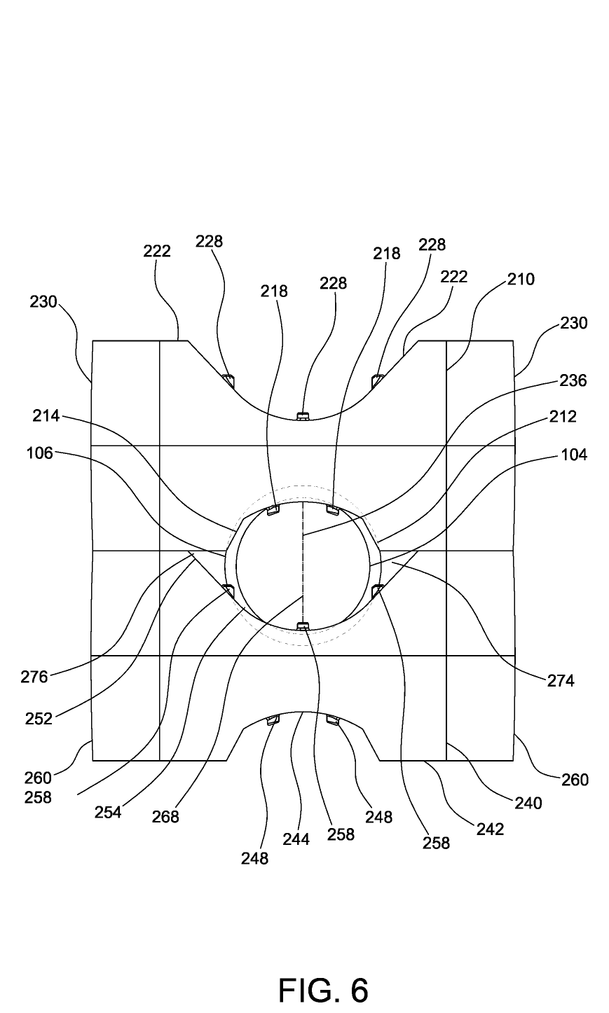

Reference is now made to FIG. 6 which shows a front view of the clamp assembly 200 (see FIG. 1) in a second arrangement for securing a cable of a second range of thickness. FIG. 6 shows, as seen in FIGS. 1-5, the clamp assembly 200 including the first piece 210 and the second piece 240. The first piece 210 includes the first side 212, the first concave portion 214, the plurality of first teeth 218, the second side 222, the second concave portion 224, the plurality of third teeth 228, and the first pair of lateral sides 230. The second piece 240 includes the third side 242, the third concave portion 244, the plurality of second small concave portion teeth 248, the fourth side 252, the fourth concave portion 254, the plurality of second large concave portion teeth 258, and the second pair of lateral sides 260. FIG. 6 further shows the first concave portion 214 having the first depth 236 and the fourth concave portion 254 having a fourth depth 268.

In the second arrangement, the first piece 210 is coupled to the second piece 240 such that the first side 212 makes physical contact with or faces the fourth side 252. Further, the clamp assembly 200 defines a second opening 274 with a second perimeter 276. In particular, the first concave portion 214 is part of a first section of the second perimeter 276 and the fourth concave portion 254 is part of a second section of the second perimeter 276.

In an overlayed format, FIG. 6 also illustrates the clamp assembly 200 securing cables of different thickness. In particular, the clamp assembly 200 is shown securing a cable 104 having a 18mm diameter or a cable 106 having a 21mm diameter. It may be appreciated that in this second arrangement, the clamp assembly 200 may secure cables having a diameter within a second range wherein the second range includes 18mm and 21mm.

FIG. 6 shows the clamp assembly 200 securing the cables 104 and 106 by having the cables 104 and 106 pass through the second opening 274. In particular, the first concave portion 214 and the fourth concave portion 254 clamp down or apply pressure on the cables 104 and 106. The plurality of first teeth 218 and the plurality of second large concave portion teeth 258 provide additional securing force or pressure.

FIG. 6 shows both the cables 104 and 106 sinking into the first concave portion 214 and the fourth concave portion 254. It may be appreciated that the cables 104 and 106 are sinking into grooves such as the one or more first grooves 216 (see FIG. 3).

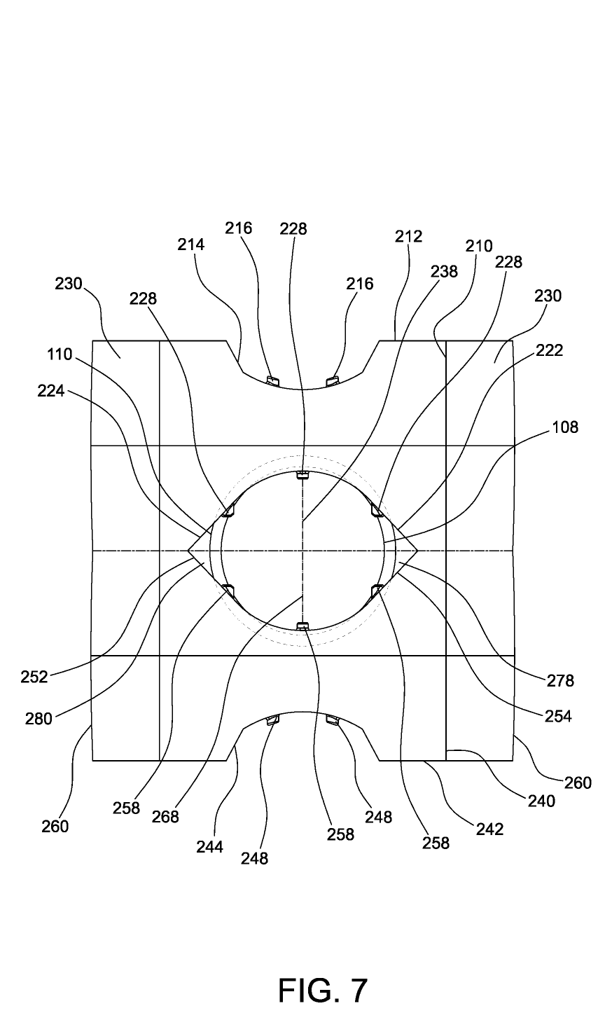

Reference is now made to FIG. 7 which shows a front view of the clamp assembly 200 (see FIG. 1) in a third arrangement for securing a cable of a third range of thickness. FIG. 7 shows, as seen in FIGS. 1-6, the clamp assembly 200 including the first piece 210 and the second piece 240. The first piece 210 includes the first side 212, the first concave portion 214, the plurality of first teeth 218, the second side 222, the second concave portion 224, the plurality of third teeth 228, and the first pair of lateral sides 230. The second piece 240 includes the third side 242, the third concave portion 244, the plurality of second small concave portion teeth 248, the fourth side 252, the fourth concave portion 254, the plurality of second large concave portion teeth 258, and the second pair of lateral sides 260. FIG. 6 further shows the first concave portion 214 having a second depth 238 and the fourth concave portion 254 having the fourth depth 268.

In the third arrangement, the first piece 210 is coupled to the second piece 240 such that the second side 222 makes physical contact with or faces the fourth side 252. Further, the clamp assembly 200 defines a third opening 278 with a third perimeter 280. In particular, the second concave portion 224 is part of a first section of the third perimeter 280 and the fourth concave portion 254 is part of a second section of the third perimeter 280.

In an overlayed format, FIG. 7 also illustrates the clamp assembly 200 securing cables of different thickness. In particular, the clamp assembly 200 is shown securing a cable 108 having a 22mm diameter or a cable 110 having a 25mm diameter. It may be appreciated that in this third arrangement, the clamp assembly 200 may secure cables having a diameter within a third range wherein the third range includes 22mm and 25mm.

FIG. 7 shows the clamp assembly 200 securing the cables 108 and 110 by having the cables 108 and 110 pass through the third opening 278. In particular, the second concave portion 224 and the fourth concave portion 254 clamp down or apply pressure on the cables 108 and 110. The plurality of third teeth 228 and the plurality of second large concave portion teeth 258 provide additional securing force or pressure.

FIG. 7 shows both the cables 108 and 110 sinking into the second concave portion 224 and the fourth concave portion 254. It may be appreciated that the cables 108 and 110 are sinking into grooves such as the one or more second grooves 226 (see FIG. 4).

Referring to FIGS. 5-7, the second depth 238 is greater than the first depth 236 and the fourth depth 268 is greater than the third depth 266. Thus, changing the arrangements (first, second or third as described with reference to FIGS. 5-7) of the clamp assembly 200 allows the clamp assembly to secure cables of varying thickness or diameters.

Additionally, certain adaptations and modifications of the described embodiments can be made. Therefore, the above discussed embodiments are considered to be illustrative and not restrictive.

1. A clamp assembly for securing an electric cable to a device and accommodating multiple cable thicknesses, the clamp assembly comprising:
a first piece, the first piece including:
a first side, the first side having a first concave portion with a first depth;
a second side on a side of the first piece opposite the first side, the second side having a second concave portion with a second depth, the second depth being greater than the first depth; and
a second piece selectively coupled to the first piece, the second piece including a third side configured to be selectively coupled to the first side and the second side, the third side having a third concave portion with a third depth, the third concave portion being configured to:
align with the first concave portion when the third side is selectively coupled to the first side; and
align with the second concave portion when the third side is selectively coupled to the second side; and
wherein selectively coupling the third side to one of the first side and the second side causes the third side and the one of the first side and the second side to define a first opening with a first perimeter, one of the first concave portion and the second concave portion being part of a first section of the first perimeter and the third concave portion being part of a second section of the first perimeter.

2. The clamp assembly of claim 1 wherein the second piece further includes a fourth side configured to be selectively coupled to the first side and the second side, the fourth side having a fourth concave portion with a fourth depth, the fourth depth being greater than the third depth and the fourth concave portion being configured to:
align with the first concave portion when the third side is selectively coupled to the first side; and
align with the second concave portion when the third side is selectively coupled to the second side; and
wherein selectively coupling the fourth side to one of the first side and the second side causes the fourth side and the one of the first side and the second side to define a second opening with a second perimeter, one of the first concave portion and the second concave portion being part of a first section of the second perimeter and the third concave portion being part of a second section of the second perimeter.

3. The clamp assembly of claim 2, wherein selectively coupling the first side to the third side allows the clamp assembly to accommodate a cable having a thickness between 14mm and17mm.

4. The clamp assembly of claim 3, wherein selectively coupling the second side to the third side allows the clamp assembly to accommodate a cable having a thickness between 18mm and 21mm.

5. The clamp assembly of claim 3, wherein selectively coupling the third side to the fourth side allows the clamp assembly to accommodate a cable having a thickness between 22mm and 25mm.

6. The clamp assembly of claim 2, wherein:
the first piece defines a first hole extending therethrough;
the second piece defines a second hole extending therethrough, the second hole being configured to align with the first hole when the first concave portion aligns with the third concave portion; and
selectively coupling the first piece to the second piece further comprises inserting a fastener through the first hole and the second hole.

7. The clamp assembly of claim 6, wherein:
the first hole has a receiving area at an end of the first hole;
the receiving area has a greater radius than another area of the first hole; and
the clamp assembly attaches to a housing by receiving, via the receiving area, a protruding part of the housing.

8. The clamp assembly of claim 7, wherein the protruding part includes a fastening area configured to receive the fastener and attaching the clamp assembly to the housing further comprises:
aligning the first hole, the second hole, and the fastening area; and
inserting the fastener through the first hole, the second hole, and the fastening area.

9. The clamp assembly of claim 1, wherein the first piece and the second piece have a common shape.

10. The clamp assembly of claim 1, wherein securing the electric cable to the device comprises passing the electric cable through the first opening.

11. A housing of a device designed to secure an electric cable to the device and accommodate multiple cable thicknesses, the housing including a clamp assembly, the clamp assembly comprising:
a first piece, the first piece including:
a first side, the first side having a first concave portion with a first depth;
a second side on a side of the first piece opposite the first side, the second side having a second concave portion with a second depth, the second depth being greater than the first depth; and
a second piece selectively coupled to the first piece, the second piece including a third side configured to be selectively couplable to the first side and the second side, the third side having a third concave portion with a third depth, the third concave portion being configured to:
align with the first concave portion when the third side is selectively coupled to the first side; and
align with the second concave portion when the third side is selectively coupled to the second side; and
wherein selectively coupling the third side to one of the first side and the second side causes the third side and the one of the first side and the second side to define a first opening with a first perimeter, one of the first concave portion and the second concave portion being part of a first section of the first perimeter and the third concave portion being part of a second section of the first perimeter.

12. The housing of claim 11 wherein the second piece further includes a fourth side configured to be selectively couplable to the first side and the second side, the fourth side having a fourth concave portion with a fourth depth, the fourth depth being greater than the third depth and the fourth concave portion being configured to:
align with the first concave portion when the third side is selectively coupled to the first side; and
align with the second concave portion when the third side is selectively coupled to the second side; and
wherein selectively coupling the fourth side to one of the first side and the second side causes the fourth side and the one of the first side and the second side to define a second opening with a second perimeter, one of the first concave portion and the second concave portion being part of a first section of the second perimeter and the third concave portion being part of a second section of the second perimeter.

13. The housing of claim 12 wherein selectively coupling the first side to the third side allows the housing to accommodate a cable having a thickness between 14mm and 17mm.

14. The housing of claim 12 wherein selectively coupling the second side to the third side allows the housing to accommodate a cable having a thickness between 18mm and 21mm.

15. The housing of claim 12 wherein selectively coupling the third side to the fourth side allows the clamp assembly to accommodate a cable having a thickness between 22mm and 25mm.

16. The housing of claim 12 wherein:
the first piece defines a first hole extending therethrough;
the second piece defines a second hole extending therethrough, the second hole being configured to align with the first hole when the first concave portion aligns with the third concave portion; and
selectively coupling the first piece to the second piece further comprises inserting a fastener through the first hole and the second hole.

17. The housing of claim 16 wherein:
the housing further comprises a protruding part;
the first hole has a receiving area at an end of the first hole;
the receiving area has a greater radius than another area of the first hole; and
the clamp assembly attaches to the housing by receiving, via the receiving area, the protruding part.

18. The housing of claim 17 wherein the protruding part includes a fastening area configured to receive the fastener and attaching the clamp assembly to the housing further comprises:
aligning the first hole, the second hole, and the fastening area; and
inserting the fastener through the first hole, the second hole, and the fastening area.

19. The housing of claim 11 wherein the first piece and the second piece have a common shape.

20. The housing of claim 11 wherein securing the electric cable to the device comprises passing the electric cable through the first opening.
